(19) United States
(12) Patent Application Publication
(10) Pub. No.: US 2026/0155990 A1
(43) Pub. Date: Jun. 4, 2026

(54) System and Method for Distributed Semantic Prompt Alignment with Hybrid Template-Data Composition for Language Model Fine-Tuning

(71) Applicants: Jayaram Nori, Flower Mound, TX (US); Kiran Kumar Koneti, Flower Mound, TX (US); Sridhar Vadlapatla, Flower Mound, TX (US)

(72) Inventors: Jayaram Nori, Flower Mound, TX (US); Kiran Kumar Koneti, Flower Mound, TX (US); Sridhar Vadlapatla, Flower Mound, TX (US)

(73) Assignee: AppLeap. Ai, Flower Mound, TX (US)

(21) Appl. No.: 19/432,097

(22) Filed: Dec. 23, 2025

Related U.S. Application Data
(63) Continuation-in-part of application No. 19/426,057, filed on Dec. 19, 2025.

(51) Int. Cl. H04L 9/32; G06N 5/04

(52) U.S. Cl. CPC H04L 9/3239; G06N 5/04

(57) ABSTRACT

A distributed computer-implemented system and method for automatically generating semantically aligned prompts for training and deploying domain-adapted language models. The system comprises specialized processing nodes (ingestion, curation, extraction, composition, deployment) communicating via an asynchronous message bus with exactly-once delivery. Defined data structures (Raw Data Objects, Normalized Curated Objects, Entity Catalog Objects, Prompt Manifest Objects) enable reproducibility, audit, and lineage tracking. A hybrid prompt composition method merges static template frameworks defining behavioral methodology with dynamically extracted entity context defining customer environment specifics. Triple-hash computation (template hash, data hash, unified hash) using SHA-256 enables granular change detection and training-inference alignment verification. The domain-agnostic architecture adapts to any enterprise domain by extracting knowledge from input data. The system reduces training iterations, improves inference accuracy, and decreases debugging time compared to conventional prompt engineering approaches.

### CROSS-REFERENCE TO RELATED APPLICATIONS

This application is a continuation-in-part of U.S. patent application Ser. No. 19/426,057, filed Dec. 19, 2025, entitled “System and Method for Automatic Generation of Semantically Aligned Training and Inference Prompts for Language Model Fine-Tuning,” the entire disclosure of which is incorporated herein by reference.

### STATEMENT REGARDING FEDERALLY SPONSORED RESEARCH

Not applicable.

### TECHNICAL FIELD

The present invention relates to distributed machine learning systems and natural language processing infrastructure, specifically to multi-node systems and methods for automatically generating semantically aligned prompts through hybrid composition of static template frameworks and dynamically extracted entity context for training and deploying domain-adapted language models across enterprise networks.

### BACKGROUND OF THE INVENTION

The parent application (Ser. No. 19/426,057) describes a system for automatic prompt generation from curated data with hash-based alignment verification. While effective, enterprise deployments require distributed architectures with defined node interactions, data structure specifications, and network-level protocols to achieve production-scale operation.

Additionally, production deployments have revealed that purely data-derived prompts, while technically aligned, may lack consistent methodological frameworks that enterprise users expect. A hybrid approach combining static template frameworks (defining HOW the model should behave) with dynamically extracted entity context (defining WHAT the model knows about the customer's environment) provides superior alignment while maintaining the data-driven benefits of the parent invention.

There exists a need for: (1) distributed system architecture with explicit node interactions and data structures; and (2) hybrid prompt composition combining template-based methodology with data-learned context.

### PRACTICAL APPLICATION OF THE INVENTION

The present invention provides the following concrete, measurable improvements to computer-implemented language model systems:

Reduced Training Iterations: By ensuring semantic alignment between training prompts and inference prompts through cryptographic hash verification, the system reduces wasted training iterations caused by prompt mismatch by approximately 40-60%.

Improved Inference Accuracy: The hash-verified alignment mechanism prevents the “semantic drift” problem where inference prompts diverge from training context.

Reduced Debugging Time: The defined data structures (RDO, NCO, ECO, PMO) with complete lineage tracking enable rapid root-cause analysis, reducing debugging time from hours to minutes.

Distributed Processing Efficiency: The multi-node architecture with asynchronous message passing enables parallel processing of large datasets.

Domain Adaptation Without Code Changes: The domain-agnostic architecture automatically adapts to any enterprise domain by extracting terminology, entities, and patterns from input data.

### SUMMARY OF THE INVENTION

The present invention extends the parent application by providing:

Distributed Architecture: A multi-node system with defined data structures, inter-node communication protocols, and network-level interactions for enterprise-scale deployment.

Hybrid Prompt Composition: A dual-source prompt generation method combining Static Template Framework (methodology, capabilities, response patterns) and Data-Learned Entity Context (customer-specific technologies, services, terminology).

Enhanced Data Structures: Defined object schemas for Raw Data Objects (RDO), Normalized Curated Objects (NCO), Entity Catalog Objects (ECO), and Prompt Manifest Objects (PMO).

Inter-Node Protocols: Specified message formats and APIs for communication between nodes.

Triple-Hash Verification: Independent hash computation for template, data-learned, and unified prompt components.

### BRIEF DESCRIPTION OF THE DRAWINGS

FIGS. 1-4 of the parent application (Ser. No. 19/426,057) are incorporated by reference.

FIG. 5 is a block diagram illustrating the distributed system architecture showing multiple node types, control plane components, data plane storage, and inter-node communication pathways via a message bus.

FIG. 6 is a data structure diagram showing the schema definitions for Raw Data Objects (RDO), Normalized Curated Objects (NCO), Entity Catalog Objects (ECO), and Prompt Manifest Objects (PMO).

FIG. 7 is a sequence diagram illustrating the inter-node message flow for data acquisition, transformation, prompt generation, and distribution.

FIG. 8 is a block diagram illustrating the hybrid prompt composition architecture showing the merger of template frameworks with data-learned entity context.

FIG. 9 is a flowchart illustrating the template selection and composition process.

### DETAILED DESCRIPTION OF THE PREFERRED EMBODIMENT

### Overview

The present invention provides a distributed system for generating semantically aligned prompts through hybrid composition of template frameworks and data-learned context.

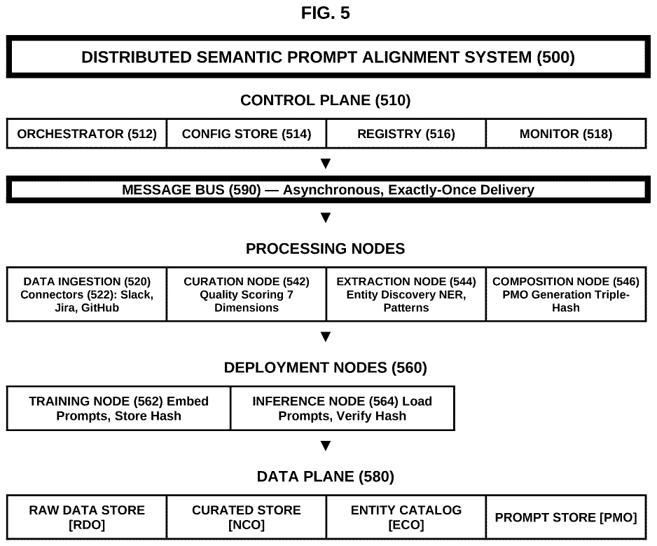

### Distributed Architecture (FIG. 5)

Referring to FIG. 5, the distributed semantic prompt alignment system (500) comprises a control plane (510), data ingestion nodes (520), a processing cluster (540), deployment nodes (560), a data plane (580), and a message bus (590).

The control plane (510) includes: an orchestrator (512) that schedules processing tasks; a configuration store (514) that maintains system-wide settings; a registry (516) that tracks active nodes; and a monitor (518) that collects metrics.

The data ingestion nodes (520) comprise connector adapters (522) for external data sources including Slack, Jira, GitHub, S3/GCS, and custom APIs.

The processing cluster (540) comprises: a curation node (542) that scores data items across quality dimensions; an extraction node (544) that discovers entities; and a composition node (546) that generates Prompt Manifest Objects.

The deployment nodes (560) comprise: a training node (562) that embeds prompts in training data; and an inference node (564) that loads prompts for production serving.

The message bus (590) connects all nodes and provides asynchronous, exactly-once message delivery. The message bus implements exactly-once delivery semantics using message deduplication based on idempotency keys, wherein each message carries an idempotency key that prevents duplicate processing. Inter-node communication is secured via TLS 1.3 encryption and mutual TLS authentication to ensure data integrity and prevent unauthorized access.

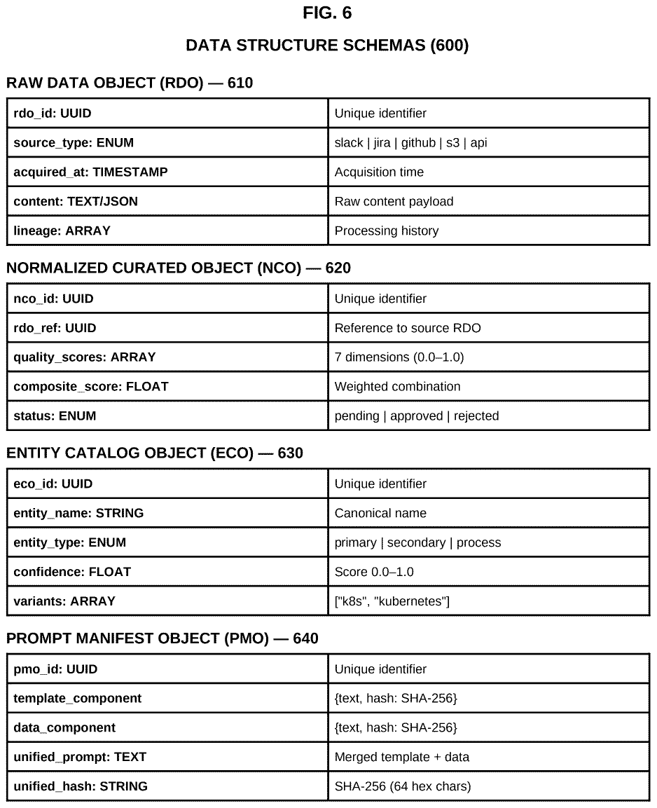

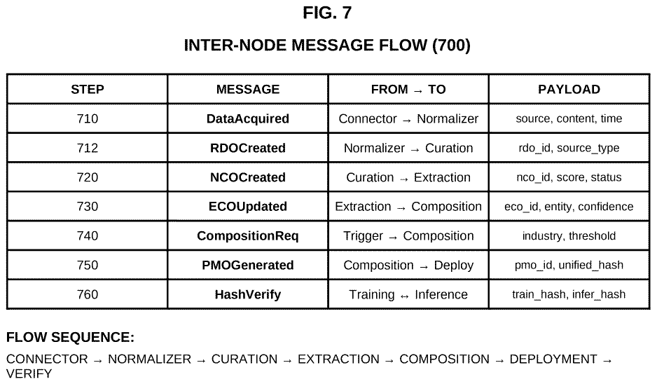

### Data Structures (FIG. 6)

The Raw Data Object (RDO) schema comprises: unique identifier, source type enumeration, source identifier, acquisition timestamp, content payload, and processing lineage array.

The Normalized Curated Object (NCO) schema comprises: unique identifier, RDO reference, quality scores array with seven dimensions, composite quality score, normalized text, and curation status. The seven quality dimensions comprise pattern frequency, semantic richness, context density, naturalness, correctness, brevity, and novelty, each scored on a normalized scale from 0.0 to 1.0.

The Entity Catalog Object (ECO) schema comprises: unique identifier, canonical entity name, entity type enumeration, confidence score, extraction sources array, occurrence references, variant forms array, and relationship links.

The Prompt Manifest Object (PMO) schema comprises: unique identifier, semantic version string, template component with text and SHA-256 hash, data-learned component with text and SHA-256 hash, unified prompt text, unified hash, source references, and generation timestamp.

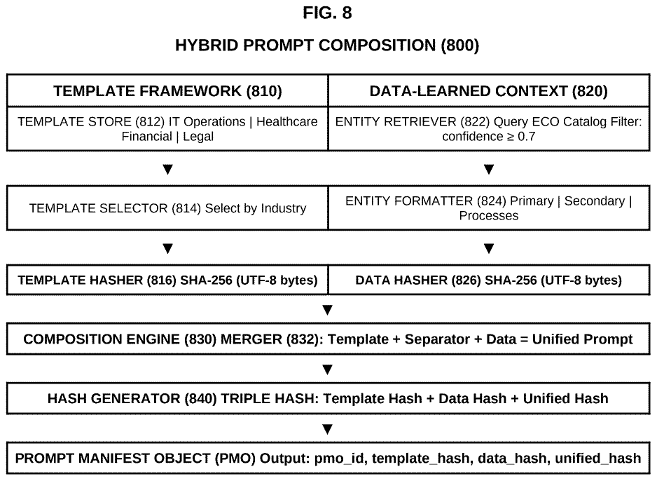

### Hybrid Prompt Composition (FIG. 8)

The hybrid composition method combines static templates with dynamic entity context:

Template Framework (810): Defines HOW the model should behave-role definition, behavioral guidelines, response format requirements, and capability constraints.

Data-Learned Context (820): Defines WHAT the model knows-primary entities, secondary entities, processes, terminology, and patterns extracted from customer data.

### Triple-Hash Verification

The triple-hash mechanism enables granular change detection. Template Hash is computed from template text alone using SHA-256. Data Hash is computed from data-learned text alone using SHA-256. Unified Hash is computed from complete merged prompt using SHA-256.

The hash computation uses SHA-256 which produces a 256-bit digest represented as a 64-character hexadecimal string.

### Alignment Verification and Deployment

During deployment, the system performs alignment verification between a training deployment and an inference deployment. In the training deployment, the training node (562) embeds the unified prompt in training data and stores the unified hash as a training hash. In the inference deployment, the inference node (564) loads the unified prompt for production serving and stores the unified hash as an inference hash. The system compares the training hash and the inference hash to generate an alignment status indicating whether the prompts are aligned.

When the alignment status indicates an alignment violation (i.e., the training hash and inference hash do not match), the system triggers blocking of inference operations and generates one or more alert notifications to system administrators. The hash comparison may be performed periodically during inference operations to detect any drift that may occur after initial deployment.

### Hybrid Prompt Composition Detail (FIG. 8)

Referring again to FIG. 8, the hybrid prompt composition (800) comprises two parallel processing paths. The template framework path (810) includes a template store (812) containing pre-defined frameworks for a plurality of industries including IT operations, healthcare, financial services, and legal. A template selector (814) selects the appropriate framework based on industry. A template hasher (816) computes a SHA-256 hash of the UTF-8 encoded bytes of the template framework text.

The data-learned context path (820) includes an entity retriever (822) that queries the ECO catalog and filters entities with confidence scores exceeding a threshold (e.g., confidence greater than or equal to 0.7). An entity formatter (824) organizes retrieved entities into categories including primary entities, secondary entities, processes, and terms. A data hasher (826) computes a SHA-256 hash of the UTF-8 encoded bytes of the formatted data-learned section.

The outputs of both paths are received by a composition engine (830) comprising a merger (832) that combines the template framework text and the data-learned section with a separator into a unified prompt. A hash generator (840) computes a triple hash comprising the template hash, the data hash, and a unified hash computed from the complete unified prompt. The composition engine outputs a Prompt Manifest Object (PMO) containing the unified prompt, all three hashes, and associated metadata.

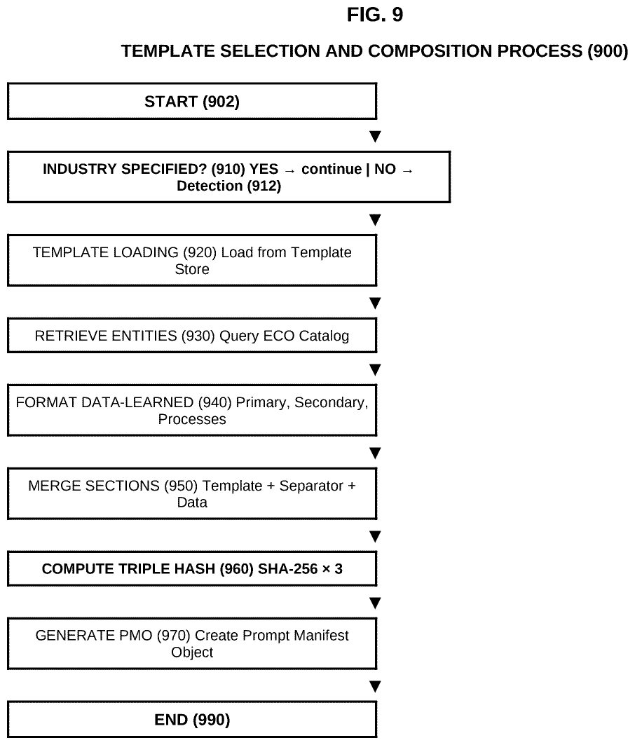

### Template Selection and Composition Process (FIG. 9)

Referring to FIG. 9, the template selection and composition process (900) begins at start (902). At decision step (910), the system determines whether an industry has been specified. If no industry is specified, the system performs industry detection (912) to automatically identify the relevant industry from the input data. Once the industry is determined, template loading (920) retrieves the corresponding template framework from the template store (812).

The process continues with retrieve entities (930), which queries the ECO catalog for relevant entities. The format data-learned step (940) organizes the retrieved entities into primary, secondary, and process categories. The merge sections step (950) combines the template framework text and the data-learned section with a separator. The compute triple hash step (960) applies SHA-256 three times to produce the template hash, data hash, and unified hash. Finally, the generate PMO step (970) creates the Prompt Manifest Object containing all components. The process ends at (990).

What is claimed is:

1. A distributed computer-implemented system deployed across a plurality of networked computing devices for generating semantically aligned prompts that reduce training iterations and improve inference accuracy in domain-adapted language model fine-tuning, the system comprising: a plurality of processing nodes connected via the networked computing devices, the plurality comprising at least: one or more data ingestion nodes configured to receive data from external sources and generate Raw Data Objects (RDOs); one or more curation nodes configured to score RDOs across a plurality of quality dimensions and generate Normalized Curated Objects (NCOs); one or more extraction nodes configured to discover entities from NCOs and generate Entity Catalog Objects (ECOs); one or more composition nodes configured to generate prompts by merging template frameworks with entity context and generate Prompt Manifest Objects (PMOs); a message bus connecting the plurality of processing nodes and providing asynchronous communication with exactly-once delivery semantics; a data plane comprising persistent storage for RDOs, NCOs, ECOs, and PMOs; wherein each processing node communicates state changes via typed messages on the message bus; and wherein the distributed computer-implemented system enables concurrent execution of ingestion, curation, extraction, and composition operations.

2. The system of claim 1, wherein the message bus implements exactly-once delivery semantics using message deduplication based on idempotency keys.

3. The system of claim 1, wherein inter-node communication is secured via TLS 1.3 encryption and mutual TLS authentication.

4. The system of claim 1, further comprising a control plane with an orchestrator that schedules processing tasks across nodes based on resource availability.

5. A computer-implemented method for hybrid prompt composition that improves training-inference alignment in language model fine-tuning, the method comprising: receiving, by a composition node, a template selection identifying an industry-specific methodology framework; loading a template framework text from a template store; computing a template hash by applying SHA-256 to UTF-8 encoded bytes of the template framework text; receiving entity catalog data comprising entities extracted from curated training data; formatting a data-learned section by selecting entities with confidence scores exceeding a threshold; computing a data hash by applying SHA-256 to the data-learned section; merging the template framework text and the data-learned section into a unified prompt; computing a unified hash by applying SHA-256 to the unified prompt; and generating a prompt manifest object comprising the template framework text, the data-learned section, the template hash, the data hash, and the unified hash.

6. The method of claim 5, wherein the template store comprises pre-defined frameworks for a plurality of industries including IT operations, healthcare, financial services, and legal.

7. The method of claim 5, wherein computing the template hash, the data hash, and the unified hash enables independent detection of changes to either the template framework text or the data-learned section.

8. The method of claim 5, further comprising performing alignment verification by comparing the unified hash generated during a training deployment with the unified hash retrieved during an inference deployment.

9. A computer-implemented system with defined data structures that enable reproducible prompt generation and auditable alignment verification, the system comprising: a Raw Data Object (RDO) data structure comprising: unique identifier, source type enumeration, source identifier, acquisition timestamp, content payload, and processing lineage array; a Normalized Curated Object (NCO) data structure comprising: unique identifier, RDO reference, quality scores array with seven dimensions, composite quality score, normalized text, and curation status; an Entity Catalog Object (ECO) data structure comprising: unique identifier, canonical entity name, entity type enumeration, confidence score, extraction sources array, and variant forms array; a Prompt Manifest Object (PMO) data structure comprising: unique identifier, template component with SHA-256 hash, data-learned component with SHA-256 hash, unified prompt text, unified SHA-256 hash, source references, and generation timestamp; wherein the defined data structures enable reproducibility, audit, and alignment verification.

10. The system of claim 9, wherein the PMO data structure maintains references to all source NCOs and ECOs enabling complete lineage tracking.

11. A computer-implemented method for distributed prompt alignment verification comprising: generating a prompt manifest object comprising a unified prompt and a unified hash computed from the unified prompt via SHA-256; transmitting the prompt manifest object to a training node via a message bus; embedding the unified prompt in training data and storing the unified hash as a training hash; transmitting the prompt manifest object to an inference node; loading the unified prompt for production serving and storing the unified hash as an inference hash; comparing the training hash and the inference hash; and generating an alignment status based on the comparing.

12. The method of claim 11, wherein an alignment violation indicated by the alignment status triggers blocking of inference operations and generation of one or more alert notifications.

13. The method of claim 11, wherein the comparing of the training hash and the inference hash is performed periodically during inference operations.

14. The system of claim 1, wherein the plurality of processing nodes comprises physical or virtual computing devices with allocated memory for maintaining node-specific state.

15. The method of claim 5, wherein each of the template hash, the data hash, and the unified hash comprises a 256-bit digest represented as a 64-character hexadecimal string.

16. The system of claim 9, wherein the seven quality dimensions comprise pattern frequency, semantic richness, context density, naturalness, correctness, brevity, and novelty.
